(19) United States
(12) Patent Application Publication
(10) Pub. No.: US 2024/0019868 A1
(43) Pub. Date: Jan. 18, 2024

(54) AUTONOMOUS MOBILE BODY, INFORMATION PROCESSING APPARATUS, INFORMATION PROCESSING METHOD, AND PROGRAM

(71) Applicant: Sony Group Corporation, Tokyo (JP)

(72) Inventor: Mariko HARUMOTO, Tokyo (JP)

(73) Assignee: Sony Group Corporation, Tokyo (JP)

(21) Appl. No.: 18/253,214

(22) PCT Filed: Nov. 12, 2021
(86) PCT No.: PCT/JP2021/041659

§ 371 Date: May 17, 2023

(30) Foreign Application Priority Data
Nov. 26, 2020 (JP) 2020-196071

(51) Int. Cl. G05D 1/02; G05D 1/00; G06V 40/10

(52) U.S. Cl. CPC G05D 1/0221; G05D 1/0234; G05D 1/0088; G06V 40/10; G05D 2201/0214

(57) ABSTRACT

The present technology relates to an autonomous mobile body, an information processing apparatus, an information processing method, and a program that enable the autonomous mobile body to quickly or reliably execute a desired action.

The autonomous mobile body includes: a recognition unit that recognizes a marker; an action planning unit that plans an action of the autonomous mobile body with respect to the marker; and a motion control unit that controls a motion of the autonomous mobile body so as to perform a planned action. The present technology can be applied to, for example, an autonomous mobile robot having a shape imitating an animal and movement capability.

### TECHNICAL FIELD

The present technology relates to an autonomous mobile body, an information processing apparatus, an information processing method, and a program, and more particularly, to an autonomous mobile body, an information processing apparatus, an information processing method, and a program that enable the autonomous mobile body to execute a desired action quickly or reliably.

### BACKGROUND ART

Conventionally, it has been proposed to cause an autonomous mobile body to execute learning related to pattern recognition, to increase recognizable targets, and to diversify actions (see, for example, Patent Document 1).

### CITATION LIST

### Patent Document

Patent Document 1: International Publication No. 2019/216016

### SUMMARY OF THE INVENTION

### Problems to be Solved by the Invention

However, in the invention described in Patent Document 1, a certain amount of time is required until the autonomous mobile body executes a desired action. Furthermore, there is a case where the training of the user fails, and the autonomous mobile body does not act as desired by the user.

The present technology has been made in view of such a situation, and enables an autonomous mobile body to execute a desired action quickly or reliably.

### Solutions to Problems

An autonomous mobile body according to a first aspect of the present technology is an autonomous mobile body that autonomously operates, the autonomous mobile body including: a recognition unit that recognizes a marker; an action planning unit that plans an action of the autonomous mobile body with respect to the marker recognized; and a motion control unit that controls a motion of the autonomous mobile body so as to perform a planned action.

In the first aspect of the present technology, a marker is recognized, an action of the autonomous mobile body with respect to the marker recognized is planned, and the motion of the autonomous mobile body is controlled so as to perform a planned action.

An autonomous mobile body according to a second aspect of the present technology includes: a recognition unit that recognizes a marker; and an action planning unit that plans an action of an autonomous mobile body with respect to the marker recognized.

An information processing method according to a second aspect of the present technology performs recognition of a marker and plans an action of an autonomous mobile body with respect to the recognized marker.

A program according to a second aspect of the present technology causes a computer to execute processing of performing recognition of a marker and planning an action of an autonomous mobile body with respect to the marker recognized.

In the second aspect of the present technology, a marker is recognized, and an action of the autonomous mobile body with respect to the marker recognized is planned.

### BRIEF DESCRIPTION OF DRAWINGS

FIG. 1 is a block diagram illustrating an embodiment of an information processing system to which the present technology is applied.

FIG. 2 is a view illustrating a hardware configuration example of an autonomous mobile body.

FIG. 3 is a configuration example of an actuator included in the autonomous mobile body.

FIG. 4 is a view for explaining a function of a display included in the autonomous mobile body.

FIG. 5 is a view illustrating a motion example of the autonomous mobile body.

FIG. 6 is a block diagram illustrating a functional configuration example of the autonomous mobile body.

FIG. 7 is a block diagram illustrating a functional configuration example of an information processing terminal.

FIG. 8 is a block diagram illustrating a functional configuration example of an information processing server.

FIG. 9 is a flowchart for explaining marker correspondence processing.

FIG. 10 is a flowchart for explaining details of individual value setting processing.

FIG. 11 is a diagram for describing a calculation example of an individual value.

FIG. 12 is a view illustrating an installation example of an approach prohibition marker.

FIG. 13 is a view illustrating an installation example of an approach prohibition marker.

FIG. 14 is a view illustrating an installation example of an approach prohibition marker.

FIG. 15 is a diagram illustrating a configuration example of a computer.

### MODE FOR CARRYING OUT THE INVENTION

Hereinafter, a mode for carrying out the present technology will be described. Note that the description will be given in the following order.
1. Embodiment
2. Modifications
3. Other

### 1. Embodiment

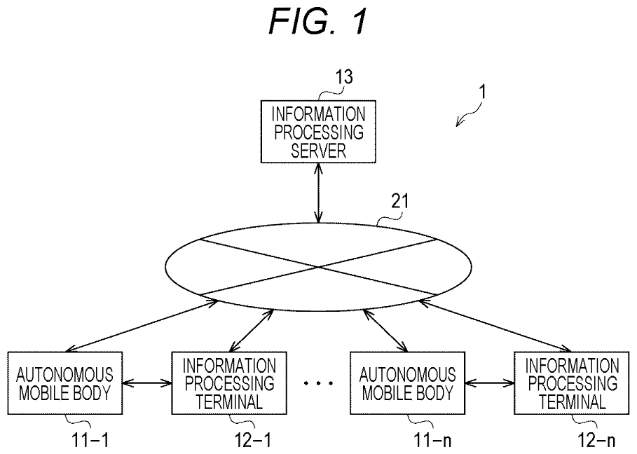

An embodiment of the present technology will be described with reference to FIGS. 1 to 14.

<Configuration Example of Information Processing System 1>

FIG. 1 is a block diagram illustrating an embodiment of an information processing system 1 to which the present technology is applied.

The information processing system 1 includes autonomous mobile bodies 11-1 to 11-n, information processing terminals 12-1 to 12-n, and an information processing server 13.

Note that, hereinafter, the autonomous mobile bodies 11-1 to 11-n are simply referred to as an autonomous mobile body 11 in a case where it is not necessary to individually distinguish from each other. Hereinafter, the information processing terminals 12-1 to 12-n are simply referred to as an information processing terminal 12 in a case where it is not necessary to individually distinguish from each other.

Between each autonomous mobile body 11 and the information processing server 13, between each information processing terminal 12 and the information processing server 13, between each autonomous mobile body 11 and each information processing terminal 12, between the individual autonomous mobile bodies 11, and between the individual information processing terminals 12, communication via a network 21 is possible. Furthermore, it is also possible to directly communicate between each autonomous mobile body 11 and each information processing terminal 12, between the individual autonomous mobile body 11, and between the individual information processing terminal 12, without using the network 21.

The autonomous mobile body 11 is an information processing apparatus that recognizes a situation of the self and surroundings on the basis of collected sensor data and the like, and autonomously selects and executes various motions according to the situation. One of features of the autonomous mobile body 11 is autonomously executing an appropriate motion according to the situation, unlike a robot that simply makes a motion according to a user's instruction.

The autonomous mobile body 11 can execute, for example, user recognition, object recognition, and the like based on a captured image, and perform various autonomous actions according to the recognized user, object, and the like. Furthermore, the autonomous mobile body 11 can execute, for example, voice recognition based on an utterance of the user, and perform an action based on a user's instruction or the like.

Moreover, the autonomous mobile body 11 performs pattern recognition learning in order to acquire ability of the user recognition and the object recognition. At this time, the autonomous mobile body 11 can dynamically collect learning data on the basis of teaching by the user or the like in addition to teacher learning based on given learning data, and can perform pattern recognition learning related to an object or the like.

Furthermore, the autonomous mobile body 11 can be trained by the user. Here, the training of the autonomous mobile body 11 is, for example, wider than general training of teaching and memorizing rules and prohibited matter, and means that a change to be felt by the user appears in the autonomous mobile body 11 as the user involves with the autonomous mobile body 11.

A shape, an ability, and a level of desire and the like of the autonomous mobile body 11 can be appropriately designed according to a purpose and a role. For example, the autonomous mobile body 11 is configured with an autonomous mobile robot that autonomously moves in a space and executes various motions. Specifically, for example, the autonomous mobile body 11 is configured with an autonomous mobile robot having a shape and movement capability imitating a human or an animal such as a dog. Furthermore, for example, the autonomous mobile body 11 is configured with a vehicle or other device having a communication capability with the user.

The information processing terminal 12 is configured with, for example, a smartphone, a tablet terminal, a personal computer (PC), or the like, and is used by the user of the autonomous mobile body 11. The information processing terminal 12 implements various functions by executing a predetermined application program (hereinafter, simply referred to as an application). For example, the information processing terminal 12 communicates with the information processing server 13 via the network 21 or directly communicates with the autonomous mobile body 11, to collect various types of data related to the autonomous mobile body 11, presents to the user, and gives an instruction to the autonomous mobile body 11.

For example, the information processing server 13 collects various types of data from each autonomous mobile body 11 and each information processing terminal 12, provides various types of data to each autonomous mobile body 11 and each information processing terminal 12, and controls motions of each autonomous mobile body 11. Furthermore, similarly to the autonomous mobile body 11, for example, the information processing server 13 can perform processing corresponding to pattern recognition learning and training by the user on the basis of data collected from each autonomous mobile body 11 and each information processing terminal 12. Moreover, for example, the information processing server 13 supplies various types of data related to the above-described application and each autonomous mobile body 11, to each information processing terminal 12.

The network 21 is configured with, for example, some of a public line network such as the Internet, a telephone line network, and a satellite communication network, various local area networks (LANs) including Ethernet (registered trademark), a wide area network (WAN), and the like. Furthermore, the network 21 may include a dedicated line network such as an Internet protocol-virtual private network (IP-VPN). Furthermore, the network 21 may include a wireless communication network such as Wi-Fi (registered trademark) or Bluetooth (registered trademark).

Note that the configuration of the information processing system 1 can be flexibly changed in accordance with specifications, operations, and the like. For example, the autonomous mobile body 11 may further perform information communication with various external devices in addition to the information processing terminal 12 and the information processing server 13. The external devices described above may include, for example, a server that sends weather, news, and other service information, various home electric appliances owned by the user, and the like.

Furthermore, for example, the autonomous mobile body 11 and the information processing terminal 12 do not necessarily have a one-to-one relationship, and may have a many-to-many, many-to-one, or one-to-many relationship, for example. For example, one user can check data related to a plurality of autonomous mobile bodies 11 by using one information processing terminal 12, or can check data related to one autonomous mobile body 11 by using a plurality of information processing terminals.

<Hardware Configuration Example of Autonomous Mobile Body 11>

Next, a hardware configuration example of the autonomous mobile body 11 will be described. Note that, hereinafter, a description is given to an example of a case where the autonomous mobile body 11 is a dog-shaped quadruped walking robot.

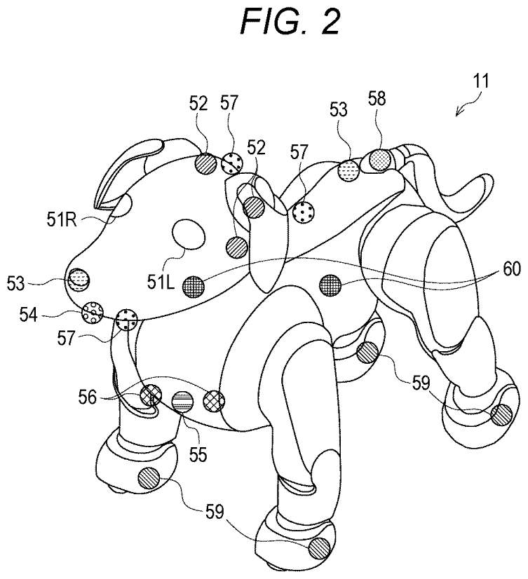

FIG. 2 is a view illustrating a hardware configuration example of the autonomous mobile body 11. The autonomous mobile body 11 is a dog-shaped quadruped walking robot including a head, a body, four legs, and a tail.

The autonomous mobile body 11 includes two displays 51L and 51R on the head. Note that, hereinafter, the display 51L and the display 51R are simply referred to as a display 51 in a case where it is not necessary to individually distinguish from each other.

Furthermore, the autonomous mobile body 11 includes various sensors. The autonomous mobile body 11 includes, for example, a microphone 52, a camera 53, a time of flight (ToF) sensor 525, a human sensor 55, a distance measuring sensor 56, a touch sensor 57, an illuminance sensor 58, a foot sole button 59, and an inertial sensor 60.

The autonomous mobile body 11 includes, for example, four microphones 52 on the head. Each microphone 52 collects, for example, surrounding sound including a user's utterance and surrounding environmental sound. Furthermore, providing a plurality of microphones 52 makes it possible to collect sounds generated in the surroundings with high sensitivity, and enables localization of a sound source.

The autonomous mobile body 11 includes, for example, two wide-angle cameras 53 at a tip of a nose and a waist, and captures an image of the surroundings of the autonomous mobile body 11. For example, the camera 53 arranged at the tip of the nose captures an image of a front visual field (that is, a field of view of the dog) of the autonomous mobile body 11. The camera 53 arranged at the waist captures an image of the surroundings centered on an upper side of the autonomous mobile body 11. The autonomous mobile body 11 can extract a feature point of a ceiling and the like on the basis of an image captured by the camera 53 arranged at the waist, for example, and can implement simultaneous localization and mapping (SLAM).

The ToF sensor 54 is provided at a tip of the nose, for example, and detects a distance to an object present in front of the head. The autonomous mobile body 11 can accurately detect distances to various objects by the ToF sensor 54, and can implement a motion according to a relative position with respect to a target object including the user, an obstacle, or the like.

The human sensor 55 is arranged on the chest, for example, and detects locations of the user, a pet raised by the user, and the like. The autonomous mobile body 11 can implement various motions on a mobile body, for example, motions according to emotions such as interest, fear, and surprise, by detecting the mobile body present in front by the human sensor 55.

The distance measuring sensor 56 is arranged on the chest, for example, and detects a situation of a floor surface in front of the autonomous mobile body 11. The autonomous mobile body 11 can accurately detect a distance to an object present on the front floor surface by the distance measuring sensor 56, and can implement a motion according to a relative position with the object.

The touch sensor 57 is arranged, for example, at a portion where the user is likely to touch the autonomous mobile body 11, such as the top of the head, under the chin, or the back, and detects the contact by the user. The touch sensor 57 is configured with, for example, a capacitive or pressure-sensitive touch sensor. The autonomous mobile body 11 can detect a contact action such as touching, stroking, hitting, or pushing by the user by the touch sensor 57, and can perform a motion according to the contact action.

The illuminance sensor 58 is arranged, for example, at a base of the tail on a back side of the head or the like, and detects illuminance of a space in which the autonomous mobile body 11 is located. The autonomous mobile body 11 can detect brightness of the surroundings by the illuminance sensor 58, and execute a motion according to the brightness.

The foot sole button 59 is arranged, for example, at each of portions corresponding to paws of the four legs, and detects whether or not a leg bottom surface of the autonomous mobile body 11 is in contact with the floor. The autonomous mobile body 11 can detect contact or non-contact with the floor surface by the foot sole button 59, and can grasp, for example, that the autonomous mobile body 11 is held and lifted by the user or the like.

The inertial sensor 60 is arranged on each of the head and the body, for example, and detects physical quantities such as a speed, an acceleration, and rotation of the head and the body. For example, the inertial sensor 60 is configured with a six-axis sensor that detects an acceleration and an angular velocity on an X-axis, a Y-axis, and a Z-axis. The autonomous mobile body 11 can accurately detect motions of the head and the body with the inertial sensor 60, and can implement motion control according to a situation.

Note that the configuration of the sensor included in the autonomous mobile body 11 can be flexibly changed in accordance with specifications, operations, and the like. For example, in addition to the configuration described above, the autonomous mobile body 11 may further include, for example, various communication devices including a temperature sensor, a geomagnetic sensor, and a global navigation satellite system (GNSS) signal receiver, or the like.

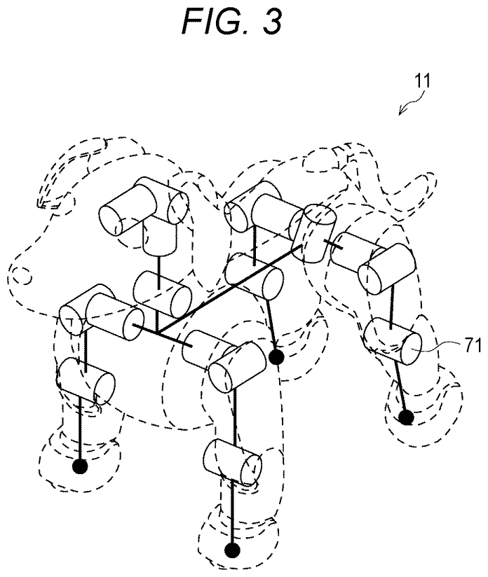

Next, with reference to FIG. 3, a configuration example of joints of the autonomous mobile body 11 will be described. FIG. 3 illustrates a configuration example of an actuator 71 included in the autonomous mobile body 11. The autonomous mobile body 11 has a total of 22 rotational degrees of freedom, two for each of the ear and the tail, and one for the mouth, in addition to the rotation portions illustrated in FIG. 3.

For example, the autonomous mobile body 11 can achieve both nodding and a head tilting motion by having three degrees of freedom in the head. Furthermore, the autonomous mobile body 11 can implement a natural and flexible motion closer to a real dog, by reproducing a swing motion of the waist by the actuator 71 provided to the waist.

Note that the autonomous mobile body 11 may implement the above-described 22 degrees of rotational freedom by combining, for example, a one-axis actuator and a two-axis actuator. For example, the one-axis actuator may be individually employed for the elbows and the knees in the legs, and the two-axis actuator may be individually employed for the shoulders and the thighs.

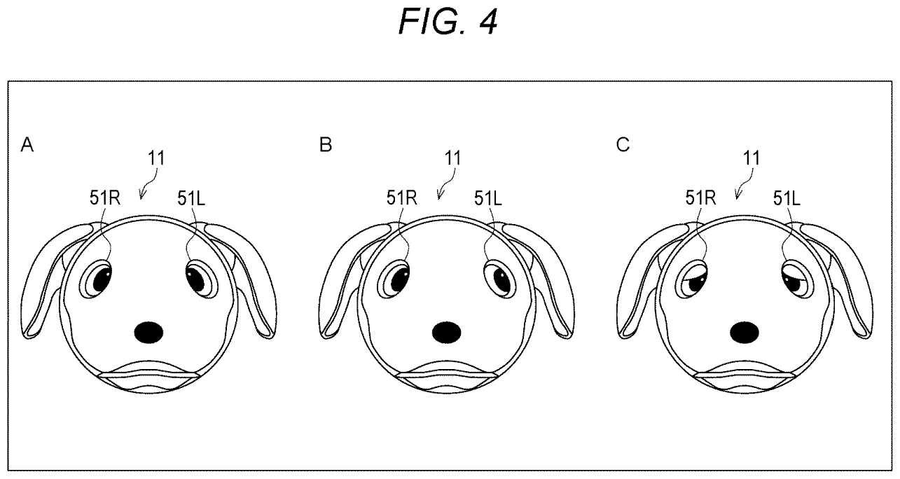

Next, with reference to FIG. 4, a function of the display 51 included in the autonomous mobile body 11 will be described.

The autonomous mobile body 11 includes the two displays 51R and 51L corresponding to the right eye and the left eye, respectively. Each display 51 has a function of visually expressing eye movement and emotions of the autonomous mobile body 11. For example, each display 51 can produce a natural motion close to an animal such as a real dog by expressing a motion of an eyeball, a pupil, and an eyelid according to an emotion and a motion, and can express a line-of-sight and an emotion of the autonomous mobile body 11 with high accuracy and flexibility. Furthermore, the user can intuitively grasp a state of the autonomous mobile body 11 from a motion of the eyeball displayed on the display 51.

Furthermore, each display 51 is implemented by, for example, two independent organic light emitting diodes (OLEDs). By using the OLED, it is possible to reproduce a curved surface of the eyeball. As a result, it is possible to implement more natural exterior as compared to a case of expressing a pair of eyeballs with one flat display, or a case of individually expressing two eyeballs with two independent flat displays.

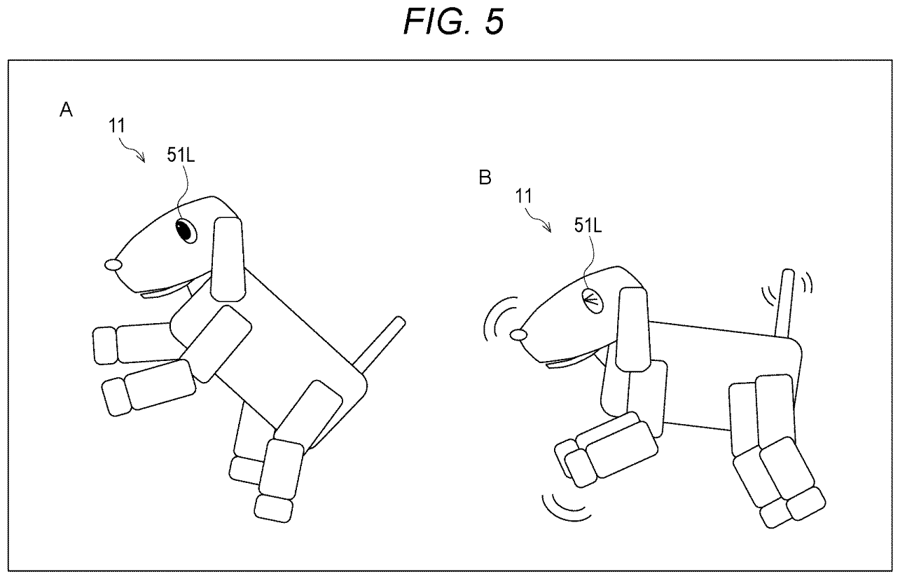

According to the configuration described above, as illustrated in FIG. 5, the autonomous mobile body 11 can reproduce a motion and emotional expression closer to a real living thing by controlling motions of the joints and the eyeballs with high accuracy and flexibility.

Note that FIG. 5 is a view illustrating a motion example of the autonomous mobile body 11, but FIG. 5 illustrates an external structure of the autonomous mobile body 11 in a simplified manner in order to describe while focusing on motions of the joints and the eyeballs of the autonomous mobile body 11.

<Functional Configuration Example of Autonomous Mobile Body 11>

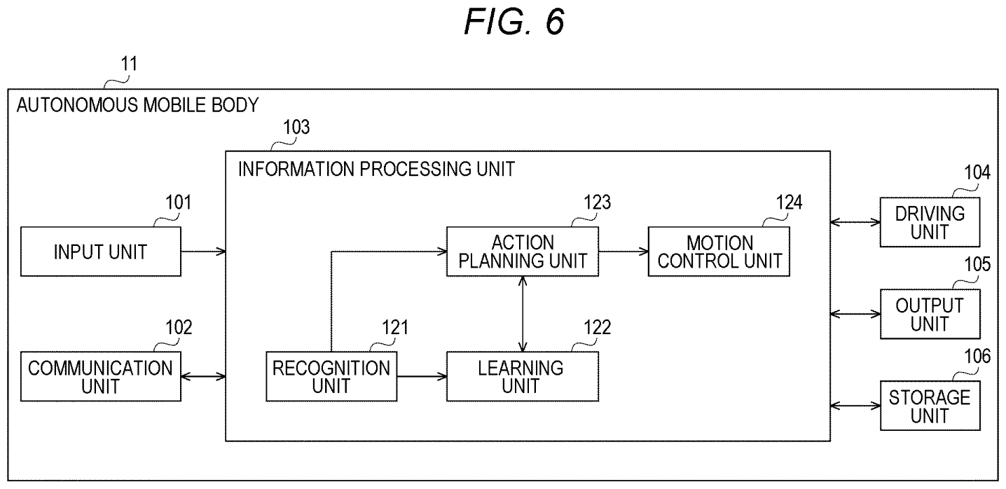

Next, with reference to FIG. 6, a functional configuration example of the autonomous mobile body 11 will be described. The autonomous mobile body 11 includes an input unit 101, a communication unit 102, an information processing unit 103, a driving unit 104, an output unit 105, and a storage unit 106.

The input unit 101 includes various sensors and the like illustrated in FIG. 2, and has a function of collecting various sensor data related to the user and a surrounding situation. Furthermore, the input unit 101 includes, for example, an input device such as a switch or a button. The input unit 101 supplies the collected sensor data and input data inputted via the input device, to the information processing unit 103.

The communication unit 102 communicates with another autonomous mobile body 11, the information processing terminal 12, and the information processing server 13 via the network 21 or not via the network 21, and transmits and receives various types of data. The communication unit 102 supplies the received data to the information processing unit 103, and acquires data to be transmitted from the information processing unit 103.

Note that the communication method of the communication unit 102 is not particularly limited, and can be flexibly changed in accordance with specifications and operations.

The information processing unit 103 includes, for example, a processor such as a central processing unit (CPU), and performs various types of information processing and controls each unit of the autonomous mobile body 11. The information processing unit 103 includes a recognition unit 121, a learning unit 122, an action planning unit 123, and a motion control unit 124.

The recognition unit 121 recognizes a situation where the autonomous mobile body 11 is placed, on the basis of the sensor data and the input data supplied from the input unit 101 and reception data supplied from the communication unit 102. The situation where the autonomous mobile body 11 is placed includes, for example, a situation of the self and the surroundings. The situation of the self includes, for example, a state and a movement of the autonomous mobile body 11. The situation of the surroundings includes, for example, a state, a movement, and an instruction of a surrounding person such as the user, a state and a movement of a surrounding living thing such as a pet, a state and a movement of a surrounding object, a time, a place, a surrounding environment, and the like. The surrounding object includes, for example, another autonomous mobile body. Furthermore, in order to recognize the situation, the recognition unit 121 performs, for example, person identification, recognition of facial expression or line-of-sight, emotion recognition, object recognition, motion recognition, spatial region recognition, color recognition, shape recognition, marker recognition, obstacle recognition, step recognition, brightness recognition, temperature recognition, voice recognition, word understanding, position estimation, posture estimation, and the like.

For example, as will be described later, the recognition unit 121 performs marker recognition for recognizing a marker installed in the real space.

Here, the marker is a member representing a predetermined two-dimensional or three-dimensional pattern. The marker pattern is represented by, for example, an image, a character, a pattern, a color, or a shape, or a combination of two or more thereof. The pattern of the marker is represented by, for example, a code such as a QR code (registered trademark), a symbol, a mark, or the like.

For example, a sheet-like member with a predetermined image or pattern is used as the marker. For example, a member having a predetermined two-dimensional shape (for example, a star) or a three-dimensional shape (for example, spherical) is used for the marker.

In addition, the type of marker is distinguished by the difference in pattern. For example, the type of marker is distinguished by the difference in pattern attached to the marker. For example, the type of marker is distinguished by the difference in shape of the marker. For example, the type of marker is distinguished by the difference in color of the marker.

Furthermore, the pattern does not necessarily need to be represented on the entire marker, and the pattern is only required to be represented only on at least a part of the marker. For example, only a part of the marker is required to have a predetermined pattern. For example, only a part of the marker is required to have a predetermined shape.

Furthermore, the recognition unit 121 has a function of estimating and understanding a situation on the basis of various types of recognized information. At this time, the recognition unit 121 may comprehensively estimate the situation by using knowledge stored in advance.

The recognition unit 121 supplies data indicating a recognition result or an estimation result of the situation (hereinafter, referred to as situation data) to the learning unit 122 and the action planning unit 123. Furthermore, the recognition unit 121 registers data indicating the recognition result or the estimation result of the situation in action history data stored in the storage unit 106.

The action history data is data indicating a history of actions of the autonomous mobile body 11. The action history data includes items of, for example, a date and time when the action is started, a date and time when the action is ended, a trigger for executing the action, a place where the action is instructed (however, in a case where a location is instructed), a situation at a time of the action, and whether or not the action has been completed (whether or not the action has been executed to the end).

As the trigger for executing the action, for example, in a case where the action is executed with a user's instruction as a trigger, a content of the instruction is registered. Furthermore, for example, in a case where the action is executed with a predetermined situation as a trigger, a content of the situation is registered. Moreover, for example, in a case where the action is executed with an object instructed by the user or a recognized object as a trigger, a type of the object is registered. The object also includes the marker described above.

The learning unit 122 learns a situation and an action, and an effect of the action on the environment, on the basis of the sensor data and the input data supplied from the input unit 101, the reception data supplied from the communication unit 102, the situation data supplied from the recognition unit 121, data related to actions of the autonomous mobile body 11 supplied from the action planning unit 123, and the action history data stored in the storage unit 106. For example, the learning unit 122 performs the pattern recognition learning described above and learns an action pattern corresponding to training by the user.

For example, the learning unit 122 implements the learning described above by using, a machine learning algorithm such as deep learning. Note that the learning algorithm employed by the learning unit 122 is not limited to the example described above, and can be designed as appropriate.

The learning unit 122 supplies data indicating a learning result (hereinafter, referred to as learning result data) to the action planning unit 123 or causes the storage unit 106 to store the data.

The action planning unit 123 plans an action to be performed by the autonomous mobile body 11 on the basis of a recognized or estimated situation and the learning result data. The action planning unit 123 supplies data indicating the planned action (hereinafter, referred to as action plan data) to the motion control unit 124. Furthermore, the action planning unit 123 supplies data related to actions of the autonomous mobile body 11 to the learning unit 122 or registers the data in the action history data stored in the storage unit 106.

The motion control unit 124 controls a motion of the autonomous mobile body 11 so as to execute the planned action, by controlling the driving unit 104 and the output unit 105 on the basis of the action plan data. The motion control unit 124 performs rotation control of the actuator 71, display control of the display 51, sound output control of a speaker, and the like, for example, on the basis of the action plan.

The driving unit 104 bends and stretches a plurality of joints included in the autonomous mobile body 11 on the basis of control by the motion control unit 124. More specifically, the driving unit 104 drives the actuator 71 included in each joint on the basis of control by the motion control unit 124.

The output unit 105 includes, for example, the display 51, a speaker, a haptic device, and the like, and outputs visual information, auditory information, tactile information, and the like on the basis of control by the motion control unit 124.

The storage unit 106 includes, for example, a nonvolatile memory and a volatile memory, and stores various programs and data.

Note that, hereinafter, description of “via the communication unit 102 and the network 21” in a case where each unit of the autonomous mobile body 11 communicates with the information processing server 13 and the like via the communication unit 102 and the network 21 will be appropriately omitted. For example, in a case where the recognition unit 121 communicates with the information processing server 13 via the communication unit 102 and the network 21, it is simply described that the recognition unit 121 communicates with the information processing server 13.

<Functional Configuration Example of Information Processing Terminal 12>

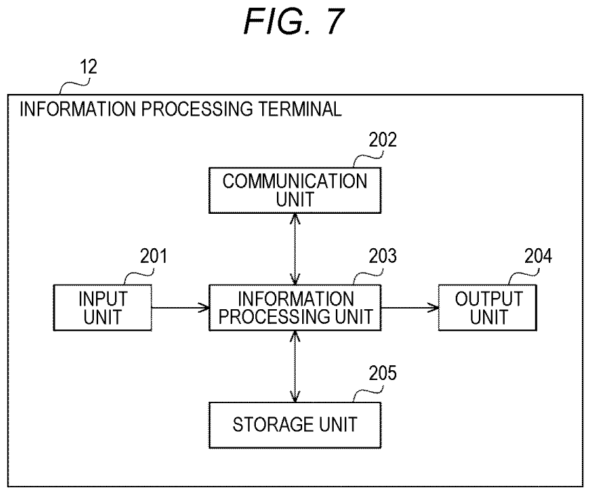

Next, with reference to FIG. 7, a functional configuration example of the information processing terminal 12 will be described. The information processing terminal 12 includes an input unit 201, a communication unit 202, an information processing unit 203, an output unit 204, and a storage unit 205.

The input unit 201 includes, for example, various sensors such as a camera (not illustrated), a microphone (not illustrated), and an inertial sensor (not illustrated). Furthermore, the input unit 201 includes input devices such as a switch (not illustrated) and a button (not illustrated). The input unit 201 supplies input data inputted via the input device and sensor data outputted from various sensors, to the information processing unit 203.

The communication unit 202 communicates with the autonomous mobile body 11, another information processing terminal 12, and the information processing server 13 via the network 21 or not via the network 21, and transmits and receives various types of data. The communication unit 202 supplies the received data to the information processing unit 203, and acquires data to be transmitted from the information processing unit 203.

Note that the communication method of the communication unit 202 is not particularly limited, and can be flexibly changed in accordance with specifications and operations.

The information processing unit 203 includes, for example, a processor such as a CPU, and performs various types of information processing and controls each unit of the information processing terminal 12.

The output unit 204 includes, for example, a display (not illustrated), a speaker (not illustrated), a haptics device (not illustrated), and the like, and outputs visual information, auditory information, tactile information, and the like on the basis of control by the information processing unit 203.

The storage unit 205 includes, for example, a nonvolatile memory and a volatile memory, and stores various programs and data.

Note that the functional configuration of the information processing terminal 12 can be flexibly changed in accordance with specifications and operations.

Furthermore, hereinafter, description of “via the communication unit 202 and the network 21” in a case where each unit of the information processing terminal 12 communicates with the information processing server 13 and the like via the communication unit 202 and the network 21 will be appropriately omitted. For example, in a case where the information processing unit 203 communicates with the information processing server 13 via the communication unit 202 and the network 21, it is simply described that the information processing unit 203 communicates with the information processing server 13.

<Functional Configuration Example of Information Processing Server 13>

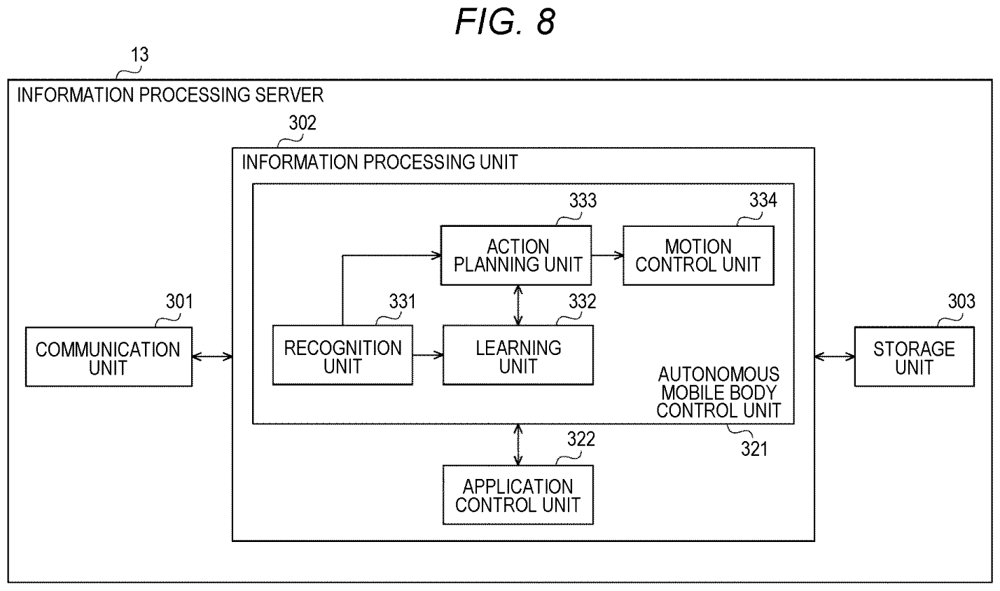

Next, with reference to FIG. 8, a functional configuration example of the information processing server 13 will be described. The information processing server 13 includes a communication unit 301, an information processing unit 302, and a storage unit 303.

The communication unit 301 communicates with each autonomous mobile body 11 and each information processing terminal 12 via the network 21, and transmits and receives various types of data. The communication unit 301 supplies the received data to the information processing unit 302, and acquires data to be transmitted from the information processing unit 302.

Note that the communication method of the communication unit 301 is not particularly limited, and can be flexibly changed in accordance with specifications and operations.

The information processing unit 302 includes, for example, a processor such as a CPU, and performs various types of information processing and controls each unit of the information processing terminal 12. The information processing unit 302 includes an autonomous mobile body control unit 321 and an application control unit 322.

The autonomous mobile body control unit 321 has a configuration similar to that of the information processing unit 103 of the autonomous mobile body 11. Specifically, the autonomous mobile body control unit 321 includes a recognition unit 331, a learning unit 332, an action planning unit 333, and a motion control unit 334.

Then, the autonomous mobile body control unit 321 has a function similar to that of the information processing unit 103 of the autonomous mobile body 11. For example, the autonomous mobile body control unit 321 receives sensor data, input data, action history data, and the like from the autonomous mobile body 11, and recognizes situations of the autonomous mobile body 11 and surroundings. For example, the autonomous mobile body control unit 321 controls a motion of the autonomous mobile body 11 by generating control data for controlling a motion of the autonomous mobile body 11 on the basis of the situations of the autonomous mobile body 11 and surroundings, and transmitting the control data to the autonomous mobile body 11. For example, similarly to the autonomous mobile body 11, the autonomous mobile body control unit 321 performs pattern recognition learning and learning of an action pattern corresponding to training by the user.

Note that the learning unit 332 of the autonomous mobile body control unit 321 can also learn collective intelligence common to a plurality of autonomous mobile bodies 11, by performing pattern recognition learning and learning of an action pattern corresponding to training by the user on the basis of data collected from a plurality of autonomous mobile bodies 11.

The application control unit 322 communicates with the autonomous mobile body 11 and the information processing terminal 12 via the communication unit 301, and controls an application executed by the information processing terminal 12.

For example, the application control unit 322 collects various types of data related to the autonomous mobile body 11, from the autonomous mobile body 11 via the communication unit 301. Then, by transmitting the collected data to the information processing terminal 12 via the communication unit 301, the application control unit 322 causes the application executed by the information processing terminal 12, to display the data related to the autonomous mobile body 11.

For example, the application control unit 322 receives, from the information processing terminal 12 via the communication unit 301, data indicating an instruction to the autonomous mobile body 11 inputted via the application. Then, the application control unit 322 transmits the received data to the autonomous mobile body 11 via the communication unit 301, to give an instruction from the user to the autonomous mobile body 11.

The storage unit 303 includes, for example, a nonvolatile memory and a volatile memory, and stores various programs and data.

Note that the functional configuration of the information processing server 13 can be flexibly changed in accordance with specifications and operations.

Furthermore, hereinafter, description of “via the communication unit 301 and the network 21” in a case where each unit of the information processing server 13 communicates with the information processing terminal 12 and the like via the communication unit 301 and the network 21 will be appropriately omitted. For example, in a case where the application control unit 322 communicates with the information processing terminal 12 via the communication unit 301 and the network 21, it is simply described that the application control unit 322 communicates with the information processing terminal 12.

<Marker Correspondence Processing>

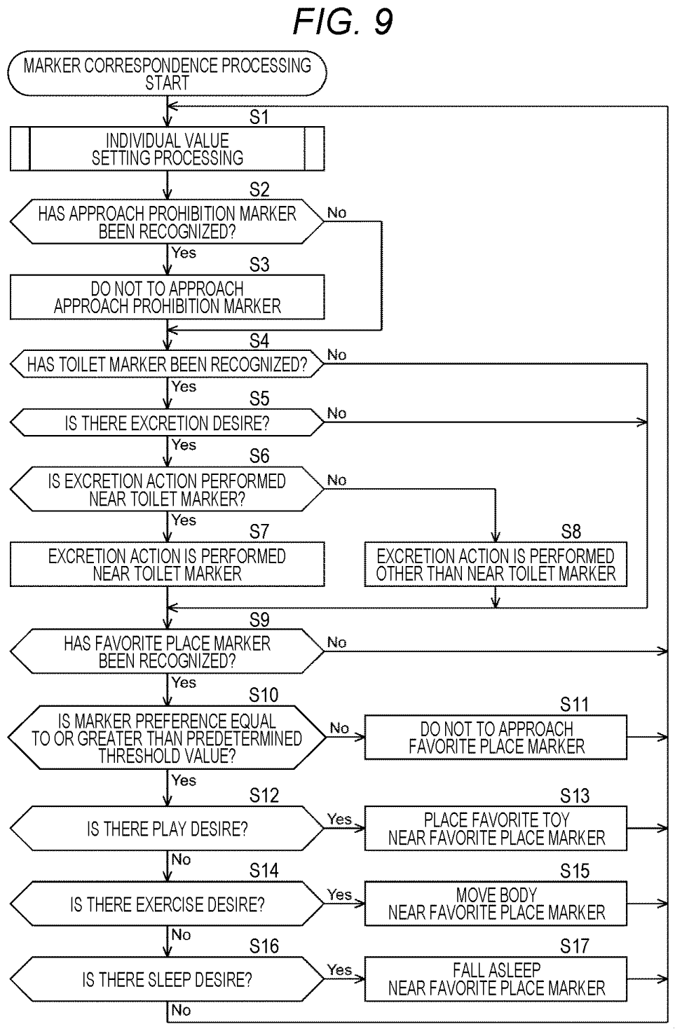

Next, marker correspondence processing executed by the autonomous mobile body 11 will be described with reference to a flowchart of FIG. 9.

Note that, hereinafter, a case where three types of markers including an approach prohibition marker, a toilet marker, and a favorite place marker are used will be described.

The approach prohibition marker is a marker for prohibiting the approach of the autonomous mobile body 11. For example, the autonomous mobile body 11 recognizes a predetermined region based on the approach prohibition marker as an entry prohibition region, and acts so as not to enter the entry prohibition region. The entry prohibition region is set to, for example, a region within a predetermined radius centered on the approach prohibition marker.

The toilet marker is a marker for designating the position of the toilet. For example, the autonomous mobile body 11 recognizes a predetermined region based on the toilet marker as a toilet region, and acts so as to perform a motion simulating an excretion action in the toilet region. Furthermore, for example, the user can train the autonomous mobile body 11 to perform a motion simulating an excretion action in the toilet region using the toilet marker. The toilet region is set, for example, in a region within a predetermined radius centered on the toilet marker.

The favorite place marker is a marker for designating a favorite place of the autonomous mobile body 11. For example, the autonomous mobile body 11 recognizes a predetermined region based on the favorite place marker as a favorite region, and performs a predetermined action in the favorite region. For example, in the favorite region, the autonomous mobile body 11 performs an action expressing a positive emotion such as joy, pleasure, and comfort such as dancing, singing, collecting favorite toys, and sleeping. The favorite region is set to, for example, a region within a predetermined radius centered on the favorite place marker.

This processing is started, for example, when the power of the autonomous mobile body 11 is turned on, and is ended when the power is turned off.

In step S1, the autonomous mobile body 11 executes individual value setting processing.

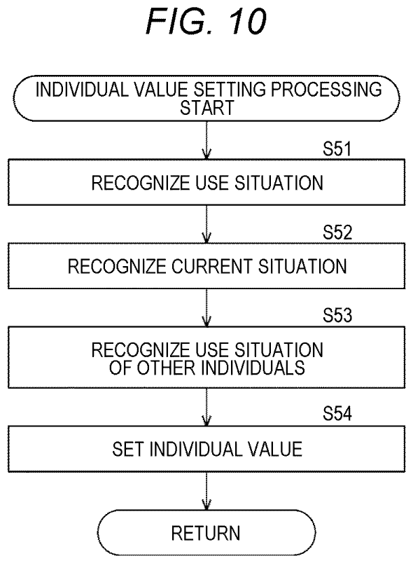

Here, the individual value setting processing will be described in detail with reference to the flowchart of FIG. 10.

In step S51, the recognition unit 121 recognizes the use situation of the autonomous mobile body 11 on the basis of the action history data stored in the storage unit 106.

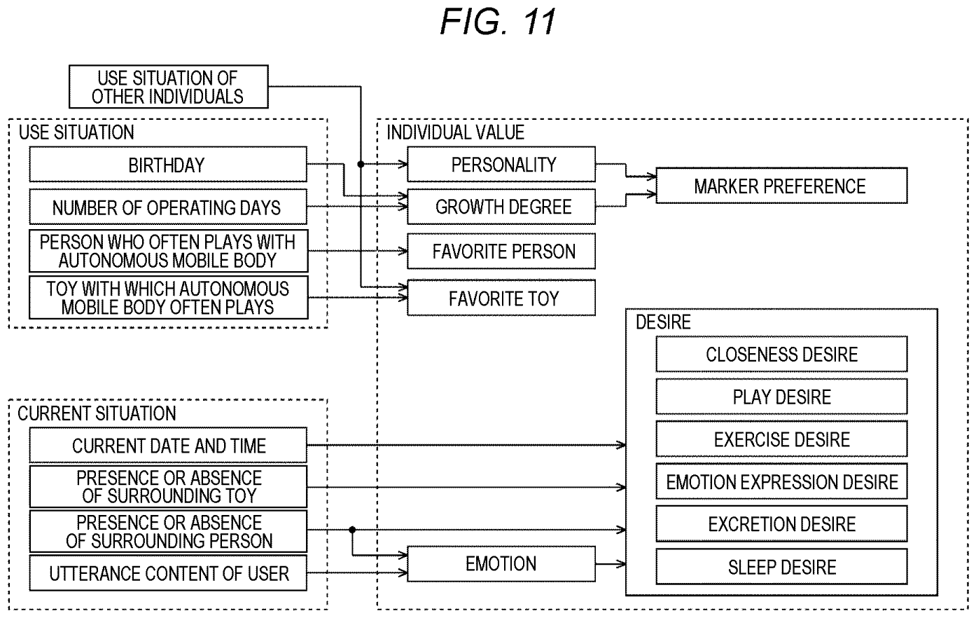

For example, as illustrated in FIG. 11, the recognition unit 121 recognizes a birthday of the autonomous mobile body 11, the number of operating days, a person who often plays with the autonomous mobile body, and a toy with which the autonomous mobile body 11 often plays as the use situation of the autonomous mobile body 11. Note that the birthday of the autonomous mobile body 11 is set to, for example, a day on which the power is turned on for the first time after the purchase of the autonomous mobile body 11. The number of operating days of the autonomous mobile body 11 is set to the number of days during which the power of the autonomous mobile body 11 is turned on and operated within the period from the birthday to the present.

The recognition unit 121 supplies data indicating a use situation of the autonomous mobile body 11 to the learning unit 122 and the action planning unit 123.

In step S52, the recognition unit 121 recognizes the current situation on the basis of the sensor data and the input data supplied from the input unit 101 and the reception data supplied from the communication unit 102.

For example, as illustrated in FIG. 11, the recognition unit 121 recognizes the current date and time, the presence or absence of a toy around the autonomous mobile body 11, the presence or absence of a person around the autonomous mobile body 11, and the utterance content of the user as the current situation.

The recognition unit 121 supplies data indicating the current situation to the learning unit 122 and the action planning unit 123.

In step S53, the recognition unit 121 recognizes a use situation of other individuals. Here, other individuals are other autonomous mobile bodies 11.

Specifically, the recognition unit 121 receives data indicating a use situation of another autonomous mobile body 11 from the information processing server 13. The recognition unit 121 recognizes the use situation of another autonomous mobile body 11 on the basis of the received data. For example, the recognition unit 121 recognizes the number of people with which each of other autonomous mobile bodies 11 has come in contact up to the present.

The recognition unit 121 supplies data indicating a use situation of another autonomous mobile body 11 to the learning unit 122 and the action planning unit 123.

In step S54, the learning unit 122 and the action planning unit 123 set the individual value on the basis of the use situation of the autonomous mobile body 11, the current situation, and the use situation of other individuals. Here, the individual value is a value indicating the current situation of the autonomous mobile body 11 on the basis of various viewpoints.

For example, as illustrated in FIG. 11, the learning unit 122 sets the personality, the growth degree, the favorite person, the favorite toy, and the marker preference of the autonomous mobile body 11 on the basis of the use situation of the autonomous mobile body 11 and other individuals.

The personality of the autonomous mobile body 11 is set, for example, on the basis of a relative relationship between a use situation of the autonomous mobile body 11 and a use situation of other individuals. For example, in a case where the number of persons who have been in contact with the autonomous mobile body 11 so far is larger than the average value of the number of persons who have been in contact with other individuals, the autonomous mobile body 11 is set to have a shy personality.

The growth degree of the autonomous mobile body 11 is set on the basis of, for example, the birthday and the number of operating days of the autonomous mobile body. For example, the growth degree is set to a higher value as the birthday of the autonomous mobile body 11 is older or the number of operating days is larger.

The marker preference indicates a preference for a favorite place marker of the autonomous mobile body 11. The marker preference is set, for example, on the basis of the personality and the growth degree of the autonomous mobile body 11. For example, as the growth degree of the autonomous mobile body 11 increases, the marker preference is set to a higher value. Furthermore, the speed at which the marker preference increases changes depending on the personality of the autonomous mobile body 11. For example, in a case where the personality of the autonomous mobile body 11 is shy, the speed at which the marker preference increases becomes slow. On the other hand, for example, in a case where the personality of the autonomous mobile body 11 is wild, the speed at which the marker preference increases becomes faster.

For example, a person who often plays with the autonomous mobile body 11 is set as a favorite person of the autonomous mobile body.

The favorite toy of the autonomous mobile body 11 is set, for example, on the basis of a use situation of other individuals and a toy with which the autonomous mobile body 11 often plays. For example, for a toy with which the autonomous mobile body 11 often plays, the preference of the autonomous mobile body 11 for the toy is set on the basis of the number of times the autonomous mobile body 11 has played with the toy and an average value of the number of times other individuals has played with the toy. For example, as the number of times the autonomous mobile body 11 has played increases compared to the average value of the number of times other individuals has played, the preference for the toy is set to a higher value. For example, as the number of times the autonomous mobile body 11 has played is smaller than the average value of the number of times other individuals has played, the preference for the toy is set to a lower value.

The learning unit 122 supplies data indicating the personality, the growth degree, the favorite person, the favorite toy, and the marker preference of the autonomous mobile body 11 to the action planning unit 123.

Furthermore, for example, as illustrated in FIG. 11, the action planning unit 123 sets the emotion and desire of the autonomous mobile body 11 on the basis of the current situation.

Specifically, the action planning unit 123 sets the emotion of the autonomous mobile body 11 on the basis of, for example, the presence or absence of a surrounding person and the utterance content of the user. For example, emotions such as joy, interest, anger, fear, surprise, and sadness are set.

For example, the action planning unit 123 sets the desire of the autonomous mobile body 11 on the basis of the current date and time, the presence or absence of a surrounding toy, the presence or absence of a surrounding person, and the emotion of the autonomous mobile body 11. The desire of the autonomous mobile body 11 includes, for example, a closeness desire, a play desire, an exercise desire, an emotion expression desire, an excretion desire, and a sleep desire.

The closeness desire indicates a desire that the autonomous mobile body 11 wants to be close to the surrounding person. For example, the action planning unit 123 sets the closeness desire level indicating the degree of closeness desire on the basis of the time zone, the presence or absence of a surrounding person, the emotion of the autonomous mobile body 11, and the like. For example, the autonomous mobile body 11 performs a motion of leaning on a surrounding person when the closeness desire level is equal to or greater than a predetermined threshold value.

The play desire indicates a desire that the autonomous mobile body 11 wants to play with an object such as a toy. For example, the action planning unit 123 sets the play desire level indicating the degree of play desire on the basis of the time zone, the presence or absence of a surrounding toy, the emotion of the autonomous mobile body 11, and the like. For example, when the play desire level is equal to or greater than a predetermined threshold value, the autonomous mobile body 11 performs a motion of playing with an object such as a toy around the autonomous mobile body.

The exercise desire represents a desire that the autonomous mobile body 11 wants to move the body. For example, the action planning unit 123 sets the exercise desire level indicating the degree of exercise desire on the basis of the time zone, the presence or absence of a surrounding toy, the presence or absence of a surrounding person, the emotion of the autonomous mobile body 11, and the like. For example, when the exercise desire level is equal to or greater than a predetermined threshold value, the autonomous mobile body 11 performs motions of moving various bodies.

The emotion expression desire represents a desire that the autonomous mobile body 11 wants to express an emotion. For example, the action planning unit 123 sets the emotion expression desire level indicating the degree of the emotion expression desire on the basis of the date, the time zone, the presence or absence of a surrounding person, the emotion of the autonomous mobile body 11, and the like. For example, when the emotion expression desire level is equal to or greater than a predetermined threshold value, the autonomous mobile body 11 performs a motion of expressing the current emotion.

The excretion desire represents a desire that the autonomous mobile body 11 wants to perform an excretion action. For example, the action planning unit 123 sets the excretion desire level indicating the degree of the excretion desire on the basis of the time zone, the emotion of the autonomous mobile body 11, and the like. For example, when the excretion desire level is equal to or greater than a predetermined threshold value, the autonomous mobile body 11 performs a motion simulating an excretion action.

The sleep desire represents a desire that the autonomous mobile body 11 wants to sleep. For example, the autonomous mobile body 11 sets the sleep desire level indicating the degree of sleep desire on the basis of the time zone, the emotion of the autonomous mobile body 11, and the like. For example, when the sleep desire level is equal to or greater than a predetermined threshold value, the autonomous mobile body 11 performs a motion simulating a sleep behavior.

Thereafter, the individual value setting processing ends.

Returning to FIG. 9, in step S2, the recognition unit 121 determines whether or not the approach prohibition marker has been recognized on the basis of the sensor data (for example, image data) supplied from the input unit 101. In a case where it is determined that the approach marker has been recognized, the processing proceeds to step S3.

In step S3, the autonomous mobile body 11 does not approach the approach prohibition marker. Specifically, the recognition unit 121 supplies data indicating the recognized position of the approach prohibition marker to the action planning unit 123.

For example, the action planning unit 123 plans an action of the autonomous mobile body 11 so as not to enter the entry prohibition region based on the approach prohibition marker. The action planning unit 123 supplies action plan data indicating the planned action to the motion control unit 124.

The motion control unit 124 controls the driving unit 104 so that the autonomous mobile body 11 does not enter the entry prohibition region on the basis of the action plan data.

Thereafter, the processing proceeds to step S4.

On the other hand, in a case where it is determined in step S2 that the approach prohibition marker is not recognized, the process of step S3 is skipped, and the processing proceeds to step S4.

In step S4, the recognition unit 121 determines whether or not the toilet marker has been recognized on the basis of the sensor data (for example, image data) supplied from the input unit 101. In a case where it is determined that the toilet marker has been recognized, the processing proceeds to step S5.

In step S5, the action planning unit 123 determines whether or not there is an excretion desire. Specifically, the recognition unit 121 supplies data indicating the recognized position of the toilet marker to the action planning unit 123. In a case where the excretion desire level set in the processing of step S1, that is, the excretion desire level when the toilet marker is recognized is equal to or greater than a predetermined threshold value, the action planning unit 123 determines that there is an excretion desire, and the processing proceeds to step S6.

In step S6, the action planning unit 123 determines whether or not to perform an excretion action near the toilet marker on the basis of the growth degree set in the processing of step S1. For example, in a case where the growth degree is equal to or greater than a predetermined threshold value, the action planning unit 123 determines to perform an excretion action near the toilet marker (that is, in the above-described toilet region).

On the other hand, for example, in a case where the growth degree is less than the predetermined threshold value, the action planning unit 123 determines whether or not to perform an excretion action near the toilet marker or perform an excretion action other than near the toilet marker with a probability according to the growth degree. For example, the higher the growth degree, the higher the probability that an excretion action is determined to be performed near the toilet marker, and the lower the growth degree, the higher the probability that an excretion action is determined to be performed outside the vicinity of the toilet marker.

Then, in a case where it is determined that the excretion action is performed near the toilet marker, the processing proceeds to step S7.

In step S7, the autonomous mobile body 11 performs an excretion action near the toilet marker. For example, the action planning unit 123 plans a motion of the autonomous mobile body 11 so as to perform a urination motion in the toilet region with the tray marker as a reference. The action planning unit 123 supplies action plan data indicating the planned action to the motion control unit 124.

The motion control unit 124 controls the driving unit 104 and the output unit 105 to perform a urination motion in the toilet region on the basis of the action plan data.

Thereafter, the processing proceeds to step S9.

On the other hand, in step S6, in a case where it is determined to perform the excretion action at a position other than the vicinity of the toilet marker, the processing proceeds to step S8.

In step S8, the autonomous mobile body 11 performs an excretion action other than near the toilet marker. Specifically, the action planning unit 123 plans an action of the autonomous mobile body 11 so that the autonomous mobile body performs a urination motion outside the tray region, for example, at the current position. The action planning unit 123 supplies action plan data indicating the planned action to the motion control unit 124.

The motion control unit 124 controls the driving unit 104 and the output unit 105 to perform a urination motion outside the toilet region on the basis of the action plan data.

Thereafter, the processing proceeds to step S9.

On the other hand, in step S5, in a case where the excretion desire level set in the processing of step S1 is less than the predetermined threshold value, the action planning unit 123 determines that there is no excretion desire, the processing of steps S6 to S8 is skipped, and the processing proceeds to step S9.

In addition, in a case where it is determined in step S4 that the tray marker is not recognized, the processing of steps S5 to S8 is skipped, and the processing proceeds to step S9.

In step S9, the recognition unit 121 determines whether or not the favorite place marker has been recognized on the basis of the sensor data (for example, image data) supplied from the input unit 101. In a case where it is determined that the favorite place marker is recognized, the processing proceeds to step S10.

In step S10, the action planning unit 123 determines whether or not the marker preference is equal to or greater than a predetermined threshold value. Specifically, the recognition unit 121 supplies data indicating the recognized position of the favorite place marker to the action planning unit 123. The action planning unit 123 determines whether or not the marker preference set in the processing of step S1, that is, the marker preference when the favorite place marker is recognized is equal to or greater than a predetermined threshold value. In a case where it is determined that the marker preference is less than the predetermined threshold value, the processing proceeds to step S11.

In step S11, the autonomous mobile body 11 does not approach the favorite place marker. Specifically, the action planning unit 123 plans an action of the autonomous mobile body 11 so as to perform a motion of being alert and not approaching the favorite place marker. The action planning unit 123 supplies action plan data indicating the planned action to the motion control unit 124.

On the basis of the action plan data, the motion control unit 124 controls the driving unit 104 and the output unit 105 so as to perform a motion of being alert and not approaching the favorite place marker.

Thereafter, the processing returns to step S1, and processing in and after step S1 is executed.

On the other hand, in a case where it is determined in step S10 that the marker preference is equal to or greater than a predetermined threshold value, the processing proceeds to step S12.

In step S12, the action planning unit 123 determines whether or not there is a play desire. In a case where the play desire level set in the processing of step S1, that is, the play desire level when the favorite place marker is recognized is equal to or greater than a predetermined threshold value, the action planning unit 123 determines that there is a play desire, and the processing proceeds to step S13.

In step S13, the autonomous mobile body 11 places a favorite toy near the favorite place marker. For example, the action planning unit 123 plans an action of the autonomous mobile body 11 so as to perform a motion of placing a toy with a preference equal to or greater than a predetermined threshold value in a favorite region with the favorite place marker as a reference. The action planning unit 123 supplies action plan data indicating the planned action to the motion control unit 124.

The motion control unit 124 controls the driving unit 104 and the output unit 105 to perform a motion of placing a favorite toy in the favorite region on the basis of the action plan data.

Thereafter, the processing returns to step S1, and processing in and after step S1 is executed.

On the other hand, in step S12, in a case where the play desire level set in the processing of step S1 is less than the predetermined threshold value, the action planning unit 123 determines that there is no play desire, and the processing proceeds to step S14.

In step S14, the action planning unit 123 determines whether or not there is an exercise desire. In a case where the exercise desire level set in the processing of step S1, that is, the exercise desire level when the favorite place marker is recognized is equal to or greater than a predetermined threshold value, the action planning unit 123 determines that there is an exercise desire, and the processing proceeds to step S15.

In step S15, the autonomous mobile body 11 moves the body near the favorite place marker. For example, the action planning unit 123 plans an action of the autonomous mobile body 11 so as to move the body in the favorite region. The action of the autonomous mobile body 11 set at this time is not always constant, and changes depending on, for example, the situation, the time, the emotion of the autonomous mobile body 11, and the like. For example, normally, a motion such as singing or dancing is set as an action of the autonomous mobile body 11. Then, rarely, a motion of digging the ground and finding the coin is set as the action of the autonomous mobile body 11. The action planning unit 123 supplies action plan data indicating the planned action to the motion control unit 124.

The motion control unit 124 controls the driving unit 104 and the output unit 105 to perform the motion set in the favorite region on the basis of the action plan data.

Thereafter, the processing returns to step S1, and processing in and after step S1 is executed.

On the other hand, in step S14, in a case where the exercise desire level set in the processing of step S1 is less than the predetermined threshold value, the action planning unit 123 determines that there is no exercise desire, and the processing proceeds to step S16.

In step S16, the action planning unit 123 determines whether or not there is a sleep desire. In a case where the sleep desire level set in the processing of step S1, that is, the sleep desire level when the favorite place marker is recognized is equal to or greater than a predetermined threshold value, the action planning unit 123 determines that there is a sleep desire, and the processing proceeds to step S17.

In step S17, the autonomous mobile body 11 falls asleep near the favorite place marker. For example, the action planning unit 123 plans an action of the autonomous mobile body 11 so that the autonomous mobile body falls asleep in the favorite region. The action planning unit 123 supplies action plan data indicating the planned action to the motion control unit 124.

The motion control unit 124 controls the driving unit 104 and the output unit 105 to perform a motion of falling asleep in the favorite region on the basis of the action plan data.

Thereafter, the processing returns to step S1, and processing in and after step S1 is executed.

On the other hand, in step S16, in a case where the sleep desire level set in the processing of step S1 is less than the predetermined threshold value, the action planning unit 123 determines that there is no sleep desire, and the processing returns to step S1. Thereafter, the processing in and after step S1 is executed.

In addition, in a case where it is determined in step S9 that the favorite place marker is not recognized, the processing returns to step S1, and the processing in and after step S1 is executed.

<Installation Example of Approach Prohibition Marker>

Next, an installation example of the approach prohibition marker will be described with reference to FIGS. 12 to 14.

Note that, hereinafter, an example of a case where the approach prohibition marker is configured by a sticker on which a predetermined pattern is printed and which can be attached to or detached from a desired place will be described.

Examples of a place where it is desirable that the autonomous mobile body 11 does not approach or enter in the house include the following places.

Since there is a risk that the autonomous mobile body 11 gets wet and breaks down in wet areas such as a kitchen, a washroom, or a bathroom, it is desirable to prevent the autonomous mobile body 11 from approaching or entering.

Since furniture, doors, walls, and the like may be damaged by collision of the autonomous mobile body 11 or may be blocked from moving, it is desirable to prevent the autonomous mobile body 11 from approaching.

Since there is a risk that the autonomous mobile body 11 may fall and be damaged, or the autonomous mobile body may be turned over and cannot move at a place having a step such as a staircase or an entrance, it is desirable to prevent the autonomous mobile body 11 from approaching.

Since the autonomous mobile body 11 may be damaged by heat by a heater such as a stove, it is desirable to prevent the autonomous mobile body 11 from approaching.

Meanwhile, for example, an approach prohibition marker is installed as follows.

FIG. 12 illustrates an example in which the autonomous mobile body 11 does not collide with the TV stand 401 on which the TV 402 is installed. For example, a marker is attached to a position P1 on the front surface of the TV stand 401. As a result, the autonomous mobile body 11 does not enter the entry prohibition region A1 based on the position P1, and is prevented from colliding with the TV stand 401.

Note that, in this example, since the width of the TV stand 401 is wide, the autonomous mobile body 11 can be prevented from colliding with the entire TV stand 401 by attaching a plurality of markers to the front surface of the TV stand 401 at predetermined intervals.

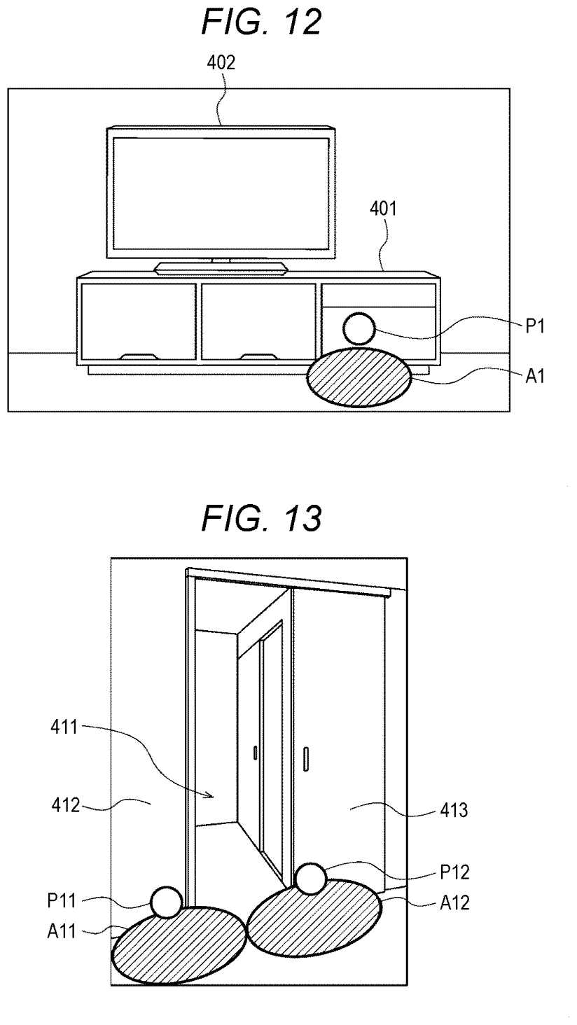

FIG. 13 illustrates an example in which the autonomous mobile body 11 is prevented from entering the washroom 411. For example, a marker is attached to a position P11 near the right end and the lower end of the left wall of the washroom 411 and a position P12 near the left end and the lower end of the door 413 of the washroom. As a result, the entry of the autonomous mobile body 11 into the entry prohibition region A11 based on the position P11 and the entry prohibition region A12 based on the position P12 is prevented.

In this case, in a state where the door 413 is opened, the right end of the entry prohibition region A11 and the left end of the entry prohibition region A12 overlap with each other. Therefore, since the entire entrance to the washroom 411 is blocked by the entry prohibition region A11 and the entry prohibition region A12, the autonomous mobile body 11 is prevented from entering the washroom 411.

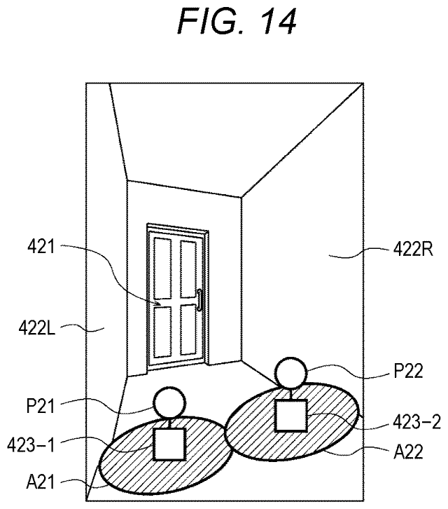

FIG. 14 illustrates an example in which the autonomous mobile body 11 is prevented from entering the entrance 412. For example, a stand 423-1 and a stand 423-2 are installed between the left wall 422L and the right wall 422R of the entrance 421 at predetermined intervals. Then, a marker is installed at a position P21 on the stand 423-1 and a position P22 on the stand 423-2. As a result, the entry of the autonomous mobile body 11 into the entry prohibition region A21 based on the position P21 and the entry prohibition region A22 based on the position P22 is prevented.

In this case, the left end of entry prohibition region A21 reaches the wall 422L, and the right end of entry prohibition region A22 reaches the wall 422R. In addition, the right end of the entry prohibition region A21 and the left end of the entry prohibition region A12 overlap each other. Therefore, since the space between the wall 422L and the wall 422R is blocked by the entry prohibition region A11 and the entry prohibition region A12, the autonomous mobile body 11 is prevented from entering the entrance 421.

As described above, the user can cause the autonomous mobile body 11 to execute a desired action quickly or reliably using the marker. As a result, the degree of satisfaction of the user with respect to the autonomous mobile body 11 is improved.

For example, by using the approach prohibition marker, the autonomous mobile body 11 is reliably prevented from entering a place where there is a risk of being damaged or stopping the motion. As a result, the user can leave the autonomous mobile body 11 powered on with security. As a result, the operation rate of the autonomous mobile body 11 increases, and the autonomous mobile body 11 can be felt as a real dog.

In addition, the user can set the toilet region at a desired position by using the toilet marker. Furthermore, the user can train the autonomous mobile body 11 to quickly and reliably perform a motion simulating an excretion action in the toilet region, and can feel the growth of the autonomous mobile body 11.

Furthermore, the user can set the favorite region to a desired place by using the favorite place marker. Furthermore, the user can train the autonomous mobile body 11 to quickly and reliably perform a predetermined motion in the favorite region, and can feel the growth of the autonomous mobile body 11.

### 2. Modifications

Hereinafter, modifications of the above-described embodiments of the present technology will be described.

<Modification Related to Marker>

First, a modification of the marker will be described.

<Modification Regarding Application of Marker>

The marker is not limited to the above-described application, and can be used for other applications.

For example, in a case where the autonomous mobile body 11 has a function of welcoming the user, the marker can be used for the purpose of designating a place where the autonomous mobile body 11 greets the user. For example, the marker may be installed near the entrance, and the autonomous mobile body 11 may wait for the user in a predetermined region based on the marker before the time when the user comes home.

For example, the autonomous mobile body 11 may learn the use of the marker by training the autonomous mobile body 11 by the user without determining the use of the marker in advance.

Specifically, for example, after installing the marker, the user gives a command to the autonomous mobile body 11 to perform a desired motion near the marker by an utterance, a gesture, or the like. For example, the user utters words such as “Please come here at 7:00 every morning.”, “Do not approach this marker.”, or the like to the autonomous mobile body 11 while pointing at the marker.

Meanwhile, the recognition unit 121 of the autonomous mobile body 11 recognizes the command of the user. The action planning unit 123 plans an action instructed near the marker according to the recognized instruction. The motion control unit 124 controls the driving unit 104 and the output unit 105 to perform the planned action.

Furthermore, the learning unit 122 learns the correspondence between the marker and the user's command. Then, as the user repeats a similar command near the marker, the learning unit 122 gradually learns the use of the marker. The action planning unit 123 plans an action for the marker on the basis of the learned use of the marker. The motion control unit 124 controls the driving unit 104 and the output unit 105 to perform the planned action.

As a result, the autonomous mobile body 11 performs a predetermined motion near the marker even without a command from the user. For example, the autonomous mobile body 11 comes near the marker at a predetermined time. Alternatively, the autonomous mobile body 11 does not perform a predetermined motion near the marker even without a command from the user. For example, the autonomous mobile body 11 does not approach the vicinity of the marker.

In this way, the user can set the application of the marker to the desired application.

Note that, for example, the user may set the use of the marker in an application executed by the information processing terminal 12. Then, the information processing terminal 12 may transmit data indicating the set use to the autonomous mobile body 11, and the autonomous mobile body 11 may recognize the use of the marker on the basis of the received data.

For example, the use of the marker may be changed by updating the software of the autonomous mobile body 11.

Specifically, for example, by installing the first version of software in the autonomous mobile body 11, the time the autonomous mobile body 11 spends near the marker increases. Next, by installing the software of the second version in the autonomous mobile body 11, the autonomous mobile body 11 further performs a motion of collecting toys near the marker. Next, by installing the software of the third version in the autonomous mobile body 11, the autonomous mobile body 11 further performs a motion of excavating near the marker and discovering virtual coins. In this way, by updating the software of the autonomous mobile body 11, the use of the marker can be added, and the action of the autonomous mobile body 11 near the marker can be added.

<Case Where Person Wears Marker>

For example, the marker may be worn by a person using a member that can be worn by the person, such as clothing, a wristband, a hat, an accessory, a badge, a name tag, or a bracelet, as the marker.

Meanwhile, for example, the recognition unit 121 of the autonomous mobile body 11 identifies the person according to whether or not the marker is attached or the type of the marker. The action planning unit 123 plans an action on the basis of a result of identifying a person. The motion control unit 124 controls the driving unit 104 and the output unit 105 to perform the planned action.

For example, in a case where the autonomous mobile body 11 serves a customer in a theme park, a commercial facility, or the like, when recognizing a person wearing a marker indicating being a special customer, the autonomous mobile body may treat the recognized person warmly. For example, the autonomous mobile body 11 may sing a song to the recognized person.

For example, in a case where the autonomous mobile body 11 plays a role such as a guard dog, in a case where the autonomous mobile body recognizes a person who is not wearing a marker serving as a passage permit, the autonomous mobile body 11 may bark, sound a warning sound, or report the person.

For example, when the autonomous mobile body 11 takes a walk outdoors, the autonomous mobile body may follow a person wearing the marker (for example, the owner of the autonomous mobile body 11).

<Case where Autonomous Mobile Body 11 Attaches Marker>

For example, a member that can be worn by the autonomous mobile body 11, such as clothing, a collar, or an accessory, may be used as the marker, and the autonomous mobile body 11 may attach the marker.

Meanwhile, for example, the recognition unit 121 of the autonomous mobile body 11 identifies another autonomous mobile body 11 according to whether or not the marker is attached or the type of the marker. The action planning unit 123 plans an action on the basis of a result of identifying another autonomous mobile body 11. The motion control unit 124 controls the driving unit 104 and the output unit 105 to perform the planned action.

For example, the autonomous mobile body 11 may consider another autonomous mobile body 11 wearing a collar as a marker of the same type as a friend and act together. For example, the autonomous mobile body 11 may play with another autonomous mobile body 11 regarded as a friend, take a walk, or eat food.

For example, in a case where a plurality of autonomous mobile bodies 11 acts separately into a plurality of teams, each autonomous mobile body 11 may identify the autonomous mobile bodies 11 of the same team and the autonomous mobile bodies 11 of other teams on the basis of the types of the markers worn by the other autonomous mobile bodies 11. For example, in a case where a plurality of autonomous mobile bodies 11 is divided into a plurality of teams and play a game such as soccer, each autonomous mobile body 11 may identify an ally and an opponent on the basis of the types of the markers worn by the other autonomous mobile bodies 11 and perform the game.

<Case of Recognizing Existing Object as Marker>

For example, the autonomous mobile body 11 may recognize an existing object as a marker instead of a dedicated marker.

For example, the autonomous mobile body 11 may recognize the traffic light as a marker. Further, the autonomous mobile body 11 may identify traffic lights in a state where a green light is turned on, a state where a yellow light is turned on, and a state where a red light is turned on as different markers. As a result, for example, the autonomous mobile body 11 can recognize the traffic light during a walk, and move on the crosswalk or temporarily stop. Furthermore, for example, the autonomous mobile body 11 can guide a visually impaired person as a guide dog.

<Virtual Marker>

For example, the user may set a virtual marker (hereinafter, referred to as a virtual marker) on the map, and the autonomous mobile body 11 may recognize the virtual marker.

For example, the user uses the information processing terminal 12 to install a virtual marker at an arbitrary position on the map indicating the floor plan of the house. The information processing terminal 12 uploads map data including a map on which the virtual marker is installed to the information processing server 13.

The recognition unit 121 of the autonomous mobile body 11 downloads the map data from the information processing server 13. The recognition unit 121 recognizes the current position of the autonomous mobile body 11, and recognizes the position of the virtual marker in the real space on the basis of the map data and the current position of the autonomous mobile body 11. Then, the autonomous mobile body 11 performs the action as described above on the basis of the position of the virtual marker in the real space.

<Other Modifications>

For example, the user may check the position of the marker recognized by the autonomous mobile body 11 using the information processing terminal 12.

For example, the recognition unit 121 of the autonomous mobile body 11 transmits data indicating the position and type of the recognized marker to the information processing server 13. For example, the information processing server 13 generates map data in which information indicating the position and type of the marker recognized by the autonomous mobile body 11 is superimposed on a map indicating the floor plan of the user's home. The information processing terminal 12 downloads map data on which information indicating the position and type of the marker is superimposed from the information processing server 13 and displays the map data.

As a result, the user can confirm the recognition situation of the marker of the autonomous mobile body 11.

Furthermore, for example, a part of the processing of the autonomous mobile body 11 described above may be executed by the information processing terminal 12 or the information processing server 13. For example, some or all of the processes of the recognition unit 121, the learning unit 122, and the action planning unit 123 of the autonomous mobile body 11 may be executed by the information processing server 13.

In this case, for example, the autonomous mobile body 11 transmits the sensor data to the information processing server 13. The information processing server 13 performs marker recognition processing on the basis of the sensor data, and plans an action of the autonomous mobile body 11 on the basis of the marker recognition result. The information processing server 13 transmits action plan data indicating the planned action to the autonomous mobile body 11. The autonomous mobile body 11 controls the driving unit 104 and the output unit 105 to perform a planned action on the basis of the received action plan data.

### 3. Others

<Configuration Example of Computer>

The series of processing described above can be executed by hardware or software. In a case where a series of processing is performed by the software, a program which forms the software is installed on a computer. Here, examples of the computer include, for example, a computer that is built in dedicated hardware, a general-purpose personal computer that can perform various functions by being installed with various programs, and the like.

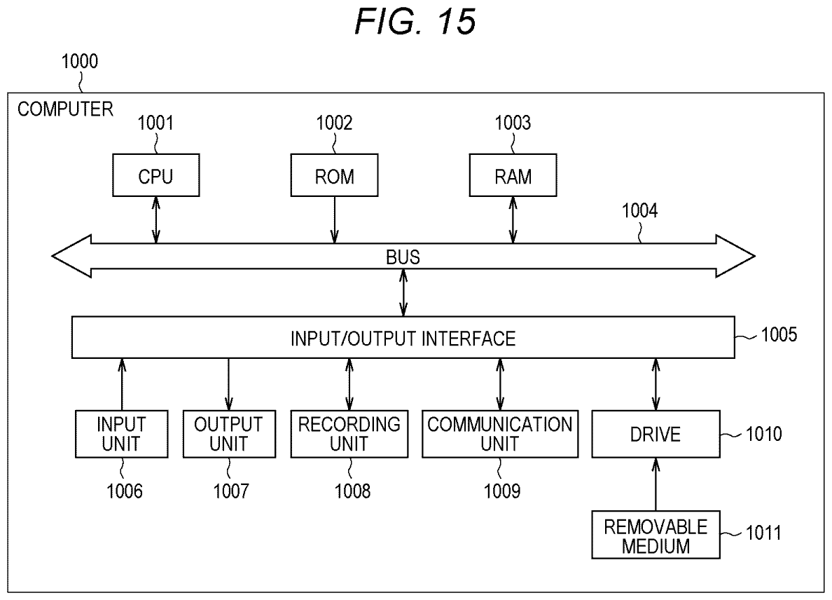

FIG. 15 is a block diagram illustrating a configuration example of hardware of a computer that executes the above-described series of processing by a program.

In a computer 1000, a central processing unit (CPU) 1001, a read only memory (ROM) 1002, and a random access memory (RAM) 1003 are mutually connected by a bus 1004.

An input/output interface 1005 is further connected to the bus 1004. An input unit 1006, an output unit 1007, a recording unit 1008, a communication unit 1009, and a drive 1010 are connected to the input/output interface 1005.

The input unit 1006 includes an input switch, a button, a microphone, an imaging element, and the like. The output unit 1007 includes a display, a speaker, and the like. The recording unit 1008 includes a hard disk, a nonvolatile memory, and the like. The communication unit 1009 includes a network interface and the like. The drive 1010 drives a removable medium 1011 such as a magnetic disk, an optical disk, a magneto-optical disk, or a semiconductor memory.

In the computer 1000 configured as above, the series of processing described above is executed by the CPU 1001 loading, for example, a program recorded in the recording unit 1008 to the RAM 1003 via the input/output interface 1005 and the bus 1004 and executing the program.

The program executed by the computer 1000 (CPU 1001) can be provided by being recorded in the removable medium 1011 as a package medium or the like, for example. Also, the program may be provided by means of a wired or wireless transmission medium such as a local region network, the Internet, and digital broadcasting.

In the computer 1000, the program can be installed in the recording unit 1008 via the input/output interface 1005 by attaching the removable medium 1011 to the drive 1010. Furthermore, the program can be received by the communication unit 1009 via a wired or wireless transmission medium and installed in the recording unit 1008. In addition, the program can be installed in the ROM 1002 or the recording unit 1008 in advance.

Note that the program executed by the computer may be a program for processing in time series in the order described in the present description, or a program for processing in parallel or at a necessary timing such as when a call is made.

Furthermore, in the present description, a system means a set of a plurality of components (devices, modules (parts), and the like), and it does not matter whether or not all components are in the same housing. Therefore, both of a plurality of devices housed in separate housings and connected via a network and a single device in which a plurality of modules is housed in one housing are systems.

Moreover, an embodiment of the present technology is not limited to the above-described embodiment, and various modifications can be made without departing from the scope of the present technology.

For example, the present technology can have a cloud computing configuration in which one function is shared and processed in cooperation by a plurality of devices via a network.

Furthermore, each step described in the above-described flowchart can be executed by one device, or can be executed in a shared manner by a plurality of devices.

Moreover, in a case where a plurality of processes is included in one step, the plurality of processes included in the one step can be executed in a shared manner by a plurality of devices, in addition to being executed by one device.

<Configuration Combination Example>

The present technology can also employ the following configurations.

(1)

An autonomous mobile body that autonomously operates, the autonomous mobile body including:
a recognition unit that recognizes a marker;
an action planning unit that plans an action of the autonomous mobile body with respect to the marker recognized; and
a motion control unit that controls a motion of the autonomous mobile body so as to perform a planned action.

(2)

The autonomous mobile body according to (1),
in which the action planning unit plans the action of the autonomous mobile body with respect to the marker on the basis of at least one of a use situation of the autonomous mobile body, a situation when the marker is recognized, or a use situation of another autonomous mobile body.

(3)

The autonomous mobile body according to (2), further including
a learning unit that sets a growth degree of the autonomous mobile body on the basis of the use situation of the autonomous mobile body,
in which the action planning unit plans the action of the autonomous mobile body with respect to the marker on the basis of the growth degree.

(4)

The autonomous mobile body according to (3),
in which the action planning unit controls a success rate of the action with respect to the marker on the basis of the growth degree.

(5)

The autonomous mobile body according to any one of (2) to (4),
in which the action planning unit sets a desire of the autonomous mobile body on the basis of the situation when the marker is recognized, and plans the action of the autonomous mobile body with respect to the marker on the basis of the desire.

(6)

The autonomous mobile body according to (5),
in which the action planning unit plans the action of the autonomous mobile body so as to perform a motion based on the desire within a predetermined region based on the marker.

(7)

The autonomous mobile body according to (5) or (6),
in which the desire includes at least one of a desire to be close to a person, a desire to play with an object, a desire to move a body, a desire to express an emotion, an excretion desire, or a sleep desire.

(8)

The autonomous mobile body according to (7),
in which in a case where a degree of the excretion desire is equal to or greater than a predetermined threshold value, the action planning unit plans the action of the autonomous mobile body so as to perform a motion simulating an excretion action within a predetermined region based on the marker.

(9)

The autonomous mobile body according to any one of (2) to (8),
in which the action planning unit sets a preference for the marker on the basis of at least one of the use situation of the autonomous mobile body or the use situation of the another autonomous mobile body, and plans the action of the autonomous mobile body with respect to the marker on the basis of the preference.

(10)

The autonomous mobile body according to (9),
in which the action planning unit plans the action of the autonomous mobile body so as not to approach the marker in a case where the preference is less than a predetermined threshold value.

(11)

The autonomous mobile body according to any one of (1) to (10), further including
a learning unit that learns an application of the marker,
in which the action planning unit plans the action of the autonomous mobile body on the basis of the application learned of the marker.

(12)

The autonomous mobile body according to any one of (1) to (11),
in which the action planning unit plans the action of the autonomous mobile body so as not to enter a predetermined region based on the marker.

(13)

The autonomous mobile body according to any one of (1) to (12),
in which the action planning unit plans the action of the autonomous mobile body on the basis of an application of the marker that changes depending on a version of software installed in the autonomous mobile body.

(14)

The autonomous mobile body according to any one of (1) to (13),
in which the recognition unit identifies a person on the basis of whether or not the marker is attached or a type of the marker, and
the action planning unit plans the action of the autonomous mobile body on the basis of an identification result of the person.

(15)

The autonomous mobile body according to any one of (1) to (14),
in which the recognition unit identifies another autonomous mobile body on the basis of whether or not the marker is attached or a type of the marker, and
the action planning unit plans the action of the autonomous mobile body on the basis of an identification result of the another autonomous mobile body.

(16)

The autonomous mobile body according to any one of (1) to (15),
in which the marker is a member representing a predetermined two-dimensional or three-dimensional pattern.

(17)

The autonomous mobile body according to any one of (1) to (16),
in which the recognition unit recognizes the marker which is virtual installed on map data on the basis of a current position of the autonomous mobile body, and
the action planning unit plans the action of the autonomous mobile body with respect to the marker which is virtual.

(18)

An information processing apparatus including:
a recognition unit that recognizes a marker; and
an action planning unit that plans an action of an autonomous mobile body with respect to the marker recognized.

(19)

An information processing method including:
performing recognition of a marker; and
planning an action of an autonomous mobile body with respect to the marker recognized.

(20)

A program for causing a computer to execute processing of:
performing recognition of a marker; and
planning an action of an autonomous mobile body with respect to the marker recognized.

Note that the effects described in the present description are merely examples and are not limited, and other effects may be provided.

### REFERENCE SIGNS LIST

1 Information processing system
11-1 to 11-n Autonomous mobile body
12-1 to 12-n Information processing terminal
13 Information processing server
101 Input unit
102 Communication unit
103 Information processing unit
104 Driving unit
105 Output unit
121 Recognition unit
122 Learning unit
123 Action planning unit
124 Motion control unit
302 Information processing unit
321 Autonomous mobile body control unit
322 Application control unit
331 Recognition unit
332 Learning unit
333 Action planning unit
334 Motion control unit

1. An autonomous mobile body that autonomously operates, the autonomous mobile body comprising:
a recognition unit that recognizes a marker;
an action planning unit that plans an action of the autonomous mobile body with respect to the marker recognized; and
a motion control unit that controls a motion of the autonomous mobile body so as to perform a planned action.

2. The autonomous mobile body according to claim 1,
wherein the action planning unit plans the action of the autonomous mobile body with respect to the marker on a basis of at least one of a use situation of the autonomous mobile body, a situation when the marker is recognized, or a use situation of another autonomous mobile body.

3. The autonomous mobile body according to claim 2, further comprising
a learning unit that sets a growth degree of the autonomous mobile body on a basis of the use situation of the autonomous mobile body,
wherein the action planning unit plans the action of the autonomous mobile body with respect to the marker on a basis of the growth degree.

4. The autonomous mobile body according to claim 3,
wherein the action planning unit controls a success rate of the action with respect to the marker on a basis of the growth degree.

5. The autonomous mobile body according to claim 2,
wherein the action planning unit sets a desire of the autonomous mobile body on a basis of the situation when the marker is recognized, and plans the action of the autonomous mobile body with respect to the marker on a basis of the desire.

6. The autonomous mobile body according to claim 5,
wherein the action planning unit plans the action of the autonomous mobile body so as to perform a motion based on the desire within a predetermined region based on the marker.

7. The autonomous mobile body according to claim 5,
wherein the desire includes at least one of a desire to be close to a person, a desire to play with an object, a desire to move a body, a desire to express an emotion, an excretion desire, or a sleep desire.

8. The autonomous mobile body according to claim 7,
wherein in a case where a degree of the excretion desire is equal to or greater than a predetermined threshold value, the action planning unit plans the action of the autonomous mobile body so as to perform a motion simulating an excretion action within a predetermined region based on the marker.

9. The autonomous mobile body according to claim 2,
wherein the action planning unit sets a preference for the marker on a basis of at least one of the use situation of the autonomous mobile body or the use situation of the another autonomous mobile body, and plans the action of the autonomous mobile body with respect to the marker on a basis of the preference.

10. The autonomous mobile body according to claim 9,
wherein the action planning unit plans the action of the autonomous mobile body so as not to approach the marker in a case where the preference is less than a predetermined threshold value.

11. The autonomous mobile body according to claim 1, further comprising
a learning unit that learns an application of the marker,
wherein the action planning unit plans the action of the autonomous mobile body on a basis of the application learned of the marker.

12. The autonomous mobile body according to claim 1,
wherein the action planning unit plans the action of the autonomous mobile body so as not to enter a predetermined region based on the marker.

13. The autonomous mobile body according to claim 1,
wherein the action planning unit plans the action of the autonomous mobile body on a basis of an application of the marker that changes depending on a version of software installed in the autonomous mobile body.

14. The autonomous mobile body according to claim 1,
wherein the recognition unit identifies a person on a basis of whether or not the marker is attached or a type of the marker, and
the action planning unit plans the action of the autonomous mobile body on a basis of an identification result of the person.

15. The autonomous mobile body according to claim 1,
wherein the recognition unit identifies another autonomous mobile body on a basis of whether or not the marker is attached or a type of the marker, and
the action planning unit plans the action of the autonomous mobile body on a basis of an identification result of the another autonomous mobile body.

16. The autonomous mobile body according to claim 1,
wherein the marker is a member representing a predetermined two-dimensional or three-dimensional pattern.

17. The autonomous mobile body according to claim 1,
wherein the recognition unit recognizes the marker which is virtual installed on map data on a basis of a current position of the autonomous mobile body, and
the action planning unit plans the action of the autonomous mobile body with respect to the marker which is virtual.

18. An information processing apparatus comprising:
a recognition unit that recognizes a marker; and
an action planning unit that plans an action of an autonomous mobile body with respect to the marker recognized.

19. An information processing method comprising:
performing recognition of a marker; and
planning an action of an autonomous mobile body with respect to the marker recognized.

20. A program for causing a computer to execute processing of:
performing recognition of a marker; and
planning an action of an autonomous mobile body with respect to the marker recognized.
